(19) United States
(12) Patent Application Publication
(10) Pub. No.: US 2023/0051216 A1
(43) Pub. Date: Feb. 16, 2023

(54) Electrothermal Ultrasonic Cleaning Ice Cream Scoop

(71) Applicant: ZHEJIANG WUYI WJL PLASTIC INDUSTRY CO.,LTD, Jinhua (CN)

(72) Inventor: Jianmin Wang, Jinhua (CN)

(73) Assignee: ZHEJIANG WUYI WJL PLASTIC INDUSTRY CO.,LTD, Jinhua (CN)

(21) Appl. No.: 17/980,559

(22) Filed: Nov. 4, 2022

(30) Foreign Application Priority Data
Sep. 14, 2022 (CN) 202211118579.2

(51) Int. Cl. A47J 43/28

(52) U.S. Cl. CPC A47J 43/282

(57) ABSTRACT

The present invention discloses an electrothermal ultrasonic cleaning ice cream scoop, and relates to the technical field of ultrasonic cleaning. The electrothermal ultrasonic cleaning ice cream scoop can be started by long pressing a button switch for two seconds. After starting, a heating element is driven by a lithium battery for heating operation until the temperature reaches 45° C., an LED lamp turns blue at the same time, and the ice cream scoop can be used directly. After use, the aluminum alloy scoop is put into clean water when needing to be cleaned, the button switch is double clicked to make the lithium battery drive a sonic motor to run.

### TECHNICAL FIELD

The present invention relates to the technical field of ultrasonic cleaning, in particularly to an electrothermal ultrasonic cleaning ice cream scoop.

### BACKGROUND

An ice cream scoop belongs to daily living equipment, mostly an aluminum alloy or stainless steel product, often having a semi-oval or semi-circular end, which is used to scoop ice cream and frequently used in daily life.

Existing ice cream scoops are generally unheated, resulting in very laborious scooping, especially for the elderly and children. Of course, ice cream scoops individually heated are available in the market, most of which are driven by a 220 V household power line, reducing the safety and convenience for the elderly and children in use. Moreover, the inside of the scoop is concave, it is more complicated to clean the scoop after use, which reduces the use effect of the equipment.

### SUMMARY

In view of the defects of the prior art, the present invention provides an electrothermal ultrasonic cleaning ice cream scoop, which solves the problems of low heating safety and poor cleaning convenience.

To achieve the above purpose, the present invention is realized through the following technical solution: an electrothermal ultrasonic cleaning ice cream scoop, comprising an upper shell and a lower shell which are fixedly connected into a whole through a plurality of screws, an aluminum alloy scoop is fixedly installed on the ends of the upper shell and the lower shell, a vibration cleaning assembly is arranged in the upper shell and the lower shell, the vibration cleaning assembly comprises a sonic motor, the sonic motor is fixedly installed in the lower shell, the outer side of the sonic motor is fixedly provided with a shockproof heat shield, the side surface of the shockproof heat shield is fixedly provided with a lithium battery, the installation position of the lithium battery is located in the upper shell, the end of the sonic motor is fixedly provided with an ultrasonic sensing rod, the end of the ultrasonic sensing rod is fixedly inserted into the aluminum alloy scoop, a control assembly used for controlling the operation of the equipment is arranged between the upper shell and the lower shell, and a heating assembly is arranged in the aluminum alloy scoop.

Preferably, a sealing strip is fixedly installed between the upper shell and the lower shell, and one end of the sealing strip is annular and is fixedly sleeved on the end of the aluminum alloy scoop through matching of the upper shell and the lower shell.

Preferably, the heating assembly comprises a heating element, the heating element is fixedly installed in the aluminum alloy scoop, and the heating element is electrically connected with the control assembly and the lithium battery through wires.

Preferably, the control assembly comprises a main circuit board, the main circuit board is fixedly installed in the upper shell, and the main circuit board is electrically connected with the heating element, the lithium battery and the sonic motor through wires.

Preferably, the outer side of the main circuit board is fixedly provided with a button switch for starting/stopping, one end of the button switch penetrates to the inside of the upper shell, and the middle part of the side surface of the main circuit board is fixedly provided with an LED lamp.

Preferably, the control assembly also comprises an assistant circuit board, the assistant circuit board is fixedly installed in the lower shell, the assistant circuit board is electrically connected with the lithium battery through wires, and the side surface of the assistant circuit board is provided with a charging terminal.

Preferably, the end of the charging terminal penetrates to the lower shell, and the penetrating end is sleeved with a waterproof silicone part.

### Beneficial Effects

The present invention provides an electrothermal ultrasonic cleaning ice cream scoop. Compared with the prior art, the present invention has the following beneficial effects:

(1) The electrothermal ultrasonic cleaning ice cream scoop can be started by long pressing the button switch for two seconds. After starting, the heating element is driven by the lithium battery for heating operation until the temperature reaches 45° C., the LED lamp turns blue at the same time, and the ice cream scoop can be used directly. After use, the aluminum alloy scoop is put into clean water when needing to be cleaned, the button switch is double clicked to make the lithium battery drive the sonic motor to run, so as to drive the aluminum alloy scoop to swing back and forth through the ultrasonic sensing rod until stains on the surface of the aluminum alloy scoop are removed, and then the button switch is pressed once to stop working, which can improve the convenience of the equipment in use and cleaning and is also convenient for the elderly and children to use, thus increasing the scope of application of the equipment.

(2) For the electrothermal ultrasonic cleaning ice cream scoop, the sealing strip arranged between the upper shell and the lower shell and the waterproof silicone part sleeved on the end of the charging terminal can effectively improve the sealing performance of the equipment, and can avoid the influence on the internal circuit elements when the equipment is used or cleaned, so as to ensure the normal operation of the equipment.

### DESCRIPTION OF DRAWINGS

FIG. 1 is an overall structural schematic diagram of the present invention;

FIG. 2 is a sectional structural schematic diagram of FIG. 1 of the present invention;

FIG. 3 is an amplified structural schematic diagram of point A of the present invention;

FIG. 4 is a sectional structural schematic diagram of the aluminum alloy scoop of the present invention;

FIG. 5 is a sectional structural schematic diagram of an upper shell and a lower shell of the present invention.

In the figures: 1. upper shell; 101. button switch; 2. lower shell; 3. aluminum alloy scoop; 301. heating element; 4. sealing strip; 5. lithium battery; 6. sonic motor; 601. ultrasonic sensing rod; 7. shockproof heat shield; 8. assistant circuit board; 801. charging terminal; 802. waterproof silicone part; 9. main circuit board; and 901. LED lamp.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

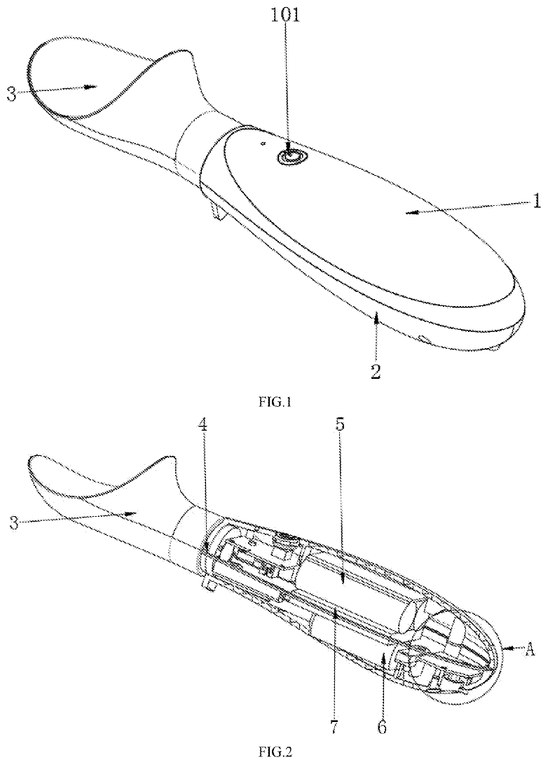

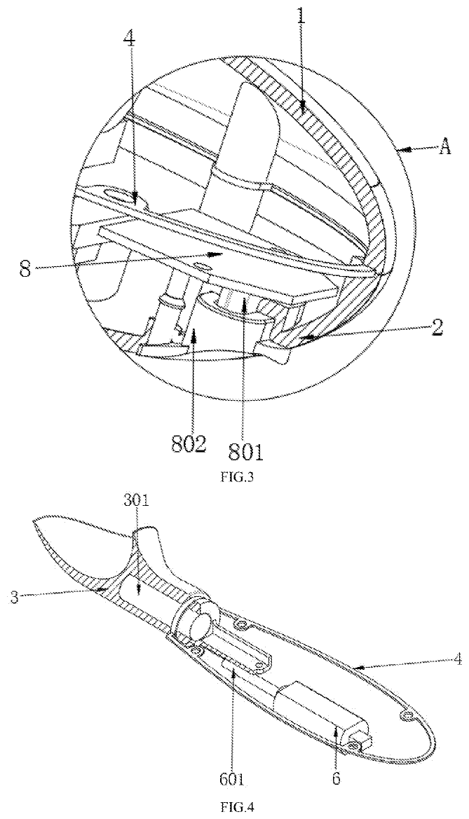

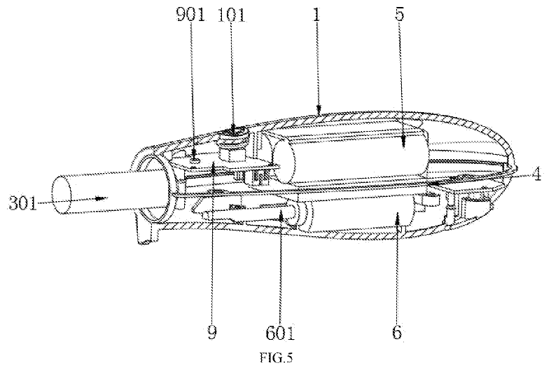

By referring to FIGS. 1-5, the present invention provides two technical solutions, comprising the following embodiments:

### Embodiment 1

An electrothermal ultrasonic cleaning ice cream scoop, comprising an upper shell 1 and a lower shell 2 which are fixedly connected into a whole through a plurality of screws, wherein an aluminum alloy scoop 3 is fixedly installed on the ends of the upper shell 1 and the lower shell 2, a vibration cleaning assembly is arranged in the upper shell 1 and the lower shell 2, the vibration cleaning assembly comprises a sonic motor 6, the sonic motor 6 is fixedly installed in the lower shell 2, the outer side of the sonic motor 6 is fixedly provided with a shockproof heat shield 7, the side surface of the shockproof heat shield 7 is fixedly provided with a lithium battery 5 which is two 18650 batteries connected in parallel, the installation position of the lithium battery 5 is located in the upper shell 1, the end of the sonic motor 6 is fixedly provided with an ultrasonic sensing rod 601, the end of the ultrasonic sensing rod 601 is fixedly inserted into the aluminum alloy scoop 3, a control assembly used for controlling the operation of the equipment is arranged between the upper shell 1 and the lower shell 2, a heating assembly is arranged in the aluminum alloy scoop 3, a sealing strip 4 is fixedly installed between the upper shell 1 and the lower shell 2, one end of the sealing strip 4 is annular and is fixedly sleeved on the end of the aluminum alloy scoop 3 through matching of the upper shell 1 and the lower shell 2, the heating assembly comprises a heating element 301 with the power of 25 W, the heating element 301 is fixedly installed in the aluminum alloy scoop 3, the heating element 301 is electrically connected with the control assembly and the lithium battery 5 through wires, the control assembly comprises a main circuit board 9, the main circuit board 9 is fixedly installed in the upper shell 1, the main circuit board 9 is electrically connected with the heating element 301, the lithium battery 5 and the sonic motor 6 through wires, the outer side of the main circuit board 9 is fixedly provided with a button switch 101 for starting/stopping, a temperature sensor is inserted into the aluminum alloy scoop 3, the temperature sensor is electrically connected with the main circuit board 9 through wires, the temperature sensor is an existing temperature sensing element, is mainly used for controlling the starting/stopping of the heating element 301, and can stop heating when the temperature reaches 45° C. during the use of the equipment, one end of the button switch 101 penetrates to the inside of the upper shell 1, the middle part of the side surface of the main circuit board 9 is fixedly provided with an LED lamp 901 which has two colors: blue and red, the LED lamp 901 is red when being charged and blue after being fully charged, the control assembly also comprises an assistant circuit board 8, the assistant circuit board 8 is fixedly installed in the lower shell 2, the assistant circuit board 8 is electrically connected with the lithium battery 5 through wires, the side surface of the assistant circuit board 8 is provided with a charging terminal 801, a charging chip uses two 4056s connected in parallel, the charging current is set to 1.6 A, the equipment is turned off when the output voltage exceeds 6 V, the end of the charging terminal 801 penetrates to the lower shell 2, and the penetrating end is sleeved with a waterproof silicone part 802.

In use, the electrothermal ultrasonic cleaning ice cream scoop can be started by long pressing the button switch 101 for two seconds. After starting, the heating element 301 is driven by the lithium battery 5 for heating operation until the temperature reaches 45° C., the LED lamp 901 turns blue at the same time, and the ice cream scoop can be used directly. After use, the aluminum alloy scoop 3 is put into clean water when needing to be cleaned, the button switch 101 is double clicked to make the lithium battery 5 drive the sonic motor 601 to run, so as to drive the aluminum alloy scoop 3 to swing back and forth at a frequency of 28000 times per minute through the ultrasonic sensing rod 601 until stains on the surface of the aluminum alloy scoop 3 are removed, and then the button switch 101 is pressed once to stop working, which can improve the convenience of the equipment in use and cleaning and is also convenient for the elderly and children to use, thus increasing the scope of application of the equipment. The lithium battery 5 can be charged through the charging terminal 801 if required. When the equipment is used or cleaned, the sealing strip 4 arranged between the upper shell 1 and the lower shell 2 and the waterproof silicone part 802 sleeved on the end of the charging terminal 801 can ensure the sealing performance of the equipment and avoid the influence on the internal circuit elements.

### Embodiment 2

An electrothermal ultrasonic cleaning ice cream scoop, comprising an upper shell 1 and a lower shell 2 which are fixedly connected into a whole through a plurality of screws, wherein an aluminum alloy scoop 3 is fixedly installed on the ends of the upper shell 1 and the lower shell 2, a vibration cleaning assembly is arranged in the upper shell 1 and the lower shell 2, the vibration cleaning assembly comprises a sonic motor 6, the sonic motor 6 is fixedly installed in the lower shell 2, the outer side of the sonic motor 6 is fixedly provided with a shockproof heat shield 7, the side surface of the shockproof heat shield 7 is fixedly provided with a lithium battery 5 which is two 18650 batteries connected in parallel, the installation position of the lithium battery 5 is located in the upper shell 1, the end of the sonic motor 6 is fixedly provided with an ultrasonic sensing rod 601, the end of the ultrasonic sensing rod 601 is fixedly inserted into the aluminum alloy scoop 3, a control assembly used for controlling the operation of the equipment is arranged between the upper shell 1 and the lower shell 2, a heating assembly is arranged in the aluminum alloy scoop 3, the heating assembly comprises a heating element 301 with the power of 25 W, the heating element 301 is fixedly installed in the aluminum alloy scoop 3, the heating element 301 is electrically connected with the control assembly and the lithium battery 5 through wires, the control assembly comprises a main circuit board 9, the main circuit board 9 is fixedly installed in the upper shell 1, the main circuit board 9 is electrically connected with the heating element 301, the lithium battery 5 and the sonic motor 6 through wires, the outer side of the main circuit board 9 is fixedly provided with a button switch 101 for starting/stopping, a temperature sensor is inserted into the aluminum alloy scoop 3, the temperature sensor is electrically connected with the main circuit board 9 through wires, the temperature sensor is an existing temperature sensing element, is mainly used for controlling the starting/stopping of the heating element 301, and can stop heating when the temperature reaches 45° C. during the use of the equipment, one end of the button switch 101 penetrates to the inside of the upper shell 1, the middle part of the side surface of the main circuit board 9 is fixedly provided with an LED lamp 901 which has two colors: blue and red, the LED lamp 901 is red when being charged and blue after being fully charged, the control assembly also comprises an assistant circuit board 8, the assistant circuit board 8 is fixedly installed in the lower shell 2, the assistant circuit board 8 is electrically connected with the lithium battery 5 through wires, the side surface of the assistant circuit board 8 is provided with a charging terminal 801, a charging chip uses two 4056s connected in parallel, the charging current is set to 1.6 A, the equipment is turned off when the output voltage exceeds 6 V, and the end of the charging terminal 801 penetrates to the lower shell 2.

In use, the electrothermal ultrasonic cleaning ice cream scoop can be started by long pressing the button switch 101 for two seconds. After starting, the heating element 301 is driven by the lithium battery 5 for heating operation until the temperature reaches 45° C., the LED lamp 901 turns blue at the same time, and the ice cream scoop can be used directly. After use, the aluminum alloy scoop 3 is put into clean water when needing to be cleaned, the button switch 101 is double clicked to make the lithium battery 5 drive the sonic motor 601 to run, so as to drive the aluminum alloy scoop 3 to swing back and forth at a frequency of 28000 times per minute through the ultrasonic sensing rod 601 until stains on the surface of the aluminum alloy scoop 3 are removed, and then the button switch 101 is pressed once to stop working, which can improve the convenience of the equipment in use and cleaning and is also convenient for the elderly and children to use, thus increasing the scope of application of the equipment. The lithium battery 5 can be charged through the charging terminal 801 if required.

The content not described in detail in the description belongs to the prior art known to those skilled in the art.

It should be noted that herein, relationship terms of first, second and the like herein are just used for differentiating one entity or operation from the other entity or operation, and do not necessarily require or imply any practical relationship or sequence between the entities or operations. Moreover, terms of “comprise”, “include” or any other variant are intended to cover non-exclusive inclusion, so that a process, a method, an article or a device which includes a series of elements not only includes such elements, but also includes other elements not listed clearly or also includes inherent elements in the process, the method, the article or the device.

Although the embodiments of the present invention have been shown and described, it will be appreciated that various variations, amendments, replacements and modifications can be made by those ordinary skilled in the art without departing from the principle and spirit of the present invention, and the scope of the present invention is limited by the appended claims and the equivalents thereof.

What is claimed is:

1. An electrothermal ultrasonic cleaning ice cream scoop, comprising an upper shell (1) and a lower shell (2) which are fixedly connected into a whole through a plurality of screws, wherein an aluminum alloy scoop (3) is fixedly installed on the ends of the upper shell (1) and the lower shell (2), and a vibration cleaning assembly is arranged in the upper shell (1) and the lower shell (2);
the vibration cleaning assembly comprises a sonic motor (6), the sonic motor (6) is fixedly installed in the lower shell (2), the outer side of the sonic motor (6) is fixedly provided with a shockproof heat shield (7), the side surface of the shockproof heat shield (7) is fixedly provided with a lithium battery (5), the installation position of the lithium battery (5) is located in the upper shell (1), the end of the sonic motor (6) is fixedly provided with an ultrasonic sensing rod (601), the end of the ultrasonic sensing rod (601) is fixedly inserted into the aluminum alloy scoop (3), a control assembly used for controlling the operation of the equipment is arranged between the upper shell (1) and the lower shell (2), and a heating assembly is arranged in the aluminum alloy scoop (3).

2. The electrothermal ultrasonic cleaning ice cream scoop according to claim 1, wherein a sealing strip (4) is fixedly installed between the upper shell (1) and the lower shell (2), and one end of the sealing strip (4) is annular and is fixedly sleeved on the end of the aluminum alloy scoop (3) through matching of the upper shell (1) and the lower shell (2).

3. The electrothermal ultrasonic cleaning ice cream scoop according to claim 1, wherein the heating assembly comprises a heating element (301), the heating element (301) is fixedly installed in the aluminum alloy scoop (3), and the heating element (301) is electrically connected with the control assembly and the lithium battery (5) through wires.

4. The electrothermal ultrasonic cleaning ice cream scoop according to claim 1, wherein the control assembly comprises a main circuit board (9), the main circuit board (9) is fixedly installed in the upper shell (1), and the main circuit board (9) is electrically connected with the heating element (301), the lithium battery (5) and the sonic motor (6) through wires.

5. The electrothermal ultrasonic cleaning ice cream scoop according to claim 4, wherein the outer side of the main circuit board (9) is fixedly provided with a button switch (101) for starting/stopping, one end of the button switch (101) penetrates to the inside of the upper shell (1), and the middle part of the side surface of the main circuit board (9) is fixedly provided with an LED lamp (901).

6. The electrothermal ultrasonic cleaning ice cream scoop according to claim 4, wherein the control assembly also comprises an assistant circuit board (8), the assistant circuit board (8) is fixedly installed in the lower shell (2), the assistant circuit board (8) is electrically connected with the lithium battery (5) through wires, and the side surface of the assistant circuit board (8) is provided with a charging terminal (801).

7. The electrothermal ultrasonic cleaning ice cream scoop according to claim 6, wherein the end of the charging terminal (801) penetrates to the lower shell (2), and the penetrating end is sleeved with a waterproof silicone part (802).
